(19) United States
(12) Patent Application Publication
(10) Pub. No.: US 2011/0273040 A1
(43) Pub. Date: Nov. 10, 2011

(54) Electric Machine Cooling System and Method

(75) Inventors: Bradley D. Chamberlin, Pendleton, IN (US); James Ramey, Fortville, IN (US); Koon Hoong Wan, Indianapolis, IN (US); Clemens Burger, Noblesville, IN (US)

(73) Assignee: Remy Technologies, LLC, Pendleton, IN (US)

(21) Appl. No.: 13/101,056

(22) Filed: May 4, 2011

Related U.S. Application Data
(60) Provisional application No. 61/347,276, filed on May 21, 2010.
(60) Provisional application No. 61/331,179, filed on May 4, 2010.

(51) Int. Cl. H02K 1/32

(52) U.S. Cl. 310/59

(57) ABSTRACT

Some embodiments of the invention provide an electric machine including a rotor assembly. In some embodiments, the rotor assembly can include a plurality of rotor laminations including at least one first aperture positioned through a portion of the rotor laminations. In some embodiments, the first apertures can form at least one magnet channel when the rotor assembly is substantially assembled. At least one permanent magnet can be positioned in each of the magnet channels. In some embodiments, at least one second aperture can be positioned through a portion of some of the laminations, along a Q-axis, and adjacent to the at magnet channel. Also, the second apertures can be configured and arranged to form at least one first coolant channel when the rotor assembly is substantially assembled.

### RELATED APPLICATIONS

This application claims priority under 35 U.S.C. §119 to U.S. Provisional Patent Applications Nos. 61/347,276 and 61/331,179 filed on May 21, 2010 and May 4, 2010, respectively, the entire contents of these applications are incorporated herein by reference.

### BACKGROUND

Electric machines, often contained within a machine cavity of a housing, generally include a stator and a rotor. During operation of electric machines, a considerable amount of heat energy can be generated by both the stator and the rotor, as well as other components of the electric machine. Some electric machines can include at least one magnet positioned in the rotor. In many machines, it is difficult to properly cool the magnets within the rotor. Cooler magnets can lead to improved machine performance. In addition, maintaining magnets at a cooler temperature can reduce their risk of demagnetization.

### SUMMARY

Some embodiments of the invention provide an electric machine including a rotor assembly. In some embodiments, the rotor assembly can include a plurality of rotor laminations including at least one first aperture positioned through at least a portion of the rotor laminations. In some embodiments, the first apertures can form at least one magnet channel when the rotor assembly is at least partially assembled. At least one permanent magnet can be positioned in each of the magnet channels. In some embodiments, at least one second aperture can be positioned through a portion of some of the laminations, along a Q-axis, and adjacent to the at least one magnet channel. Also, the second apertures can be configured and arranged to form at least one first coolant channel when the rotor assembly is substantially assembled.

Some embodiments of the invention can provide an electric machine including a stator assembly that can include stator end turns and a rotor assembly. In some embodiments, a module housing can enclose the electric machine and at least a portion of the module housing can define a machine cavity. In some embodiments, the rotor assembly can include at least one magnet channel and at least one first coolant channel. In some embodiments, the magnet channel and the first coolant channel can extend in a substantially axial direction through at least a portion of the rotor assembly. In some embodiments, a permanent magnet can be positioned in the magnet channel. Moreover, in some embodiments, the first coolant channel can be positioned along a Q-axis adjacent to the magnet channel and at least one coolant guide can be operatively coupled to the rotor assembly.

### DESCRIPTION OF THE DRAWINGS

FIG. 1 is a cross-sectional view of an electric machine module according to one embodiment of the invention.

FIG. 2 is a side view of a conventional rotor lamination for use in an electric machine module.

FIG. 3 is a cross-sectional view of an electric machine according to one embodiment of the invention.

FIG. 4 is a side view of a rotor lamination, according to one embodiment of the invention, for use in the electric machine module of FIG. 3.

FIG. 5A is another side view of a rotor lamination, according to one embodiment of the invention, for use in the electric machine module of FIG. 3.

FIG. 5B is a partial side view of the rotor lamination of FIG. 5A.

FIG. 6A is a side view of a rotor lamination, according to another embodiment of the invention, for use in the electric machine module of FIG. 3.

FIG. 6B is a partial side view of the rotor lamination of FIG. 6A.

FIG. 7 is a partial cross-sectional view of an electric machine according to one embodiment of the invention.

FIG. 8 is a partial cross-sectional view of an electric machine according to one embodiment of the invention.

FIG. 9 is partial perspective cross-sectional view of an electric machine according to one embodiment of the invention.

FIGS. 10A and 10B are views of a coolant guide according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

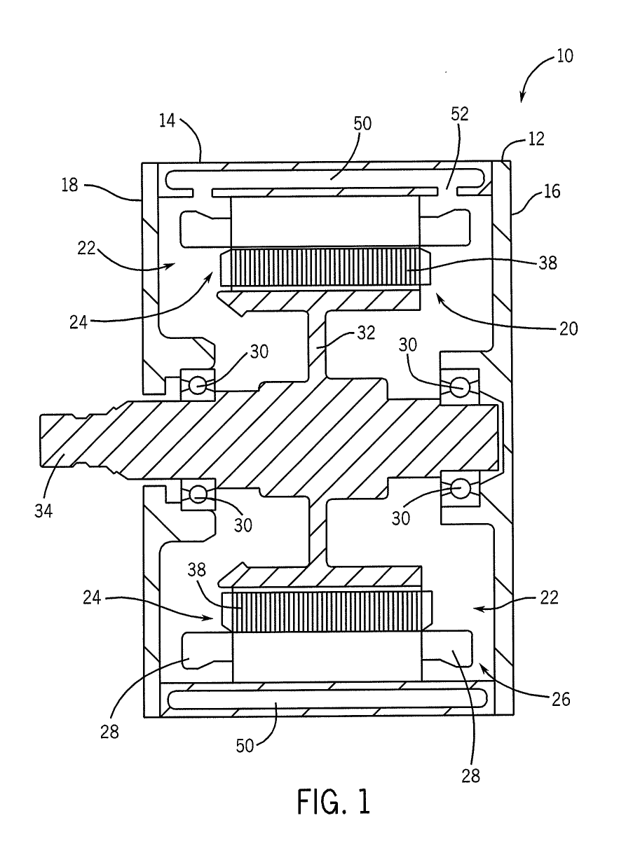

FIG. 1 illustrates an electric machine module 10 according to one embodiment of the invention. The module 10 can include a module housing 12 comprising a sleeve member 14, a first end cap 16, and a second end cap 18. An electric machine 20 can be housed within a machine cavity 22 at least partially defined by the sleeve member 14 and the end caps 16, 18. For example, the sleeve member 14 and the end caps 16, 18 can be coupled via conventional fasteners (not shown), or another suitable coupling method, to enclose at least a portion of the electric machine 20 within the machine cavity 22. In some embodiments the housing 12 can comprise a substantially cylindrical canister and a single end cap (not shown). Further, in some embodiments, the module housing 12, including the sleeve member 14 and the end caps 16, 18, can comprise materials that can generally include thermally conductive properties, such as, but not limited to aluminum or other metals and materials capable of generally withstanding operating temperatures of the electric machine. In some embodiments, the housing 12 can be fabricated using different methods including casting, molding, extruding, and other similar manufacturing methods.

The electric machine 20 can be, without limitation, an electric motor, such as a hybrid electric motor, an electric generator, or a vehicle alternator. In one embodiment, the electric machine 20 can be a High Voltage Hairpin (HVH) electric motor or an interior permanent magnet electric motor for hybrid vehicle applications.

The electric machine 20 can include a rotor assembly 24, a stator assembly 26, including stator end turns 28, and bearings 30, and can be disposed about an output shaft 34. As shown in FIG. 1, the stator 26 can substantially circumscribe a portion of the rotor 24. In some embodiments, the electric machine 20 can also include a rotor hub 32 or can have a “hub-less” design (not shown).

Components of the electric machine 20 such as, but not limited to, the rotor 24, the stator assembly 26, and the stator end turns 28 can generate heat during operation of the electric machine 20. These components can be cooled to increase the performance and the lifespan of the electric machine 20.

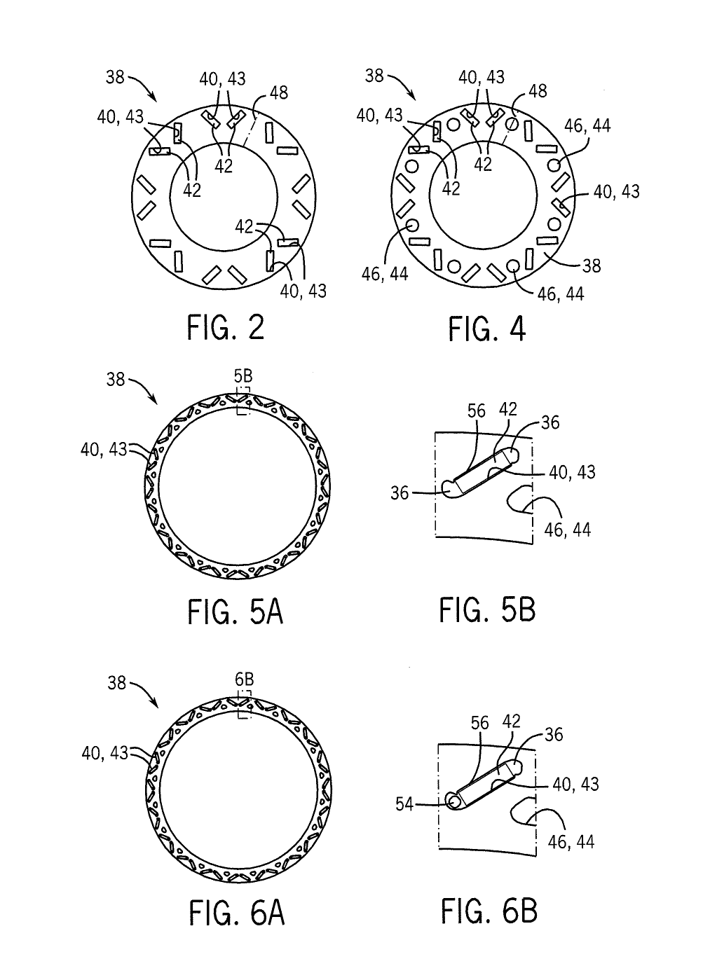

In some embodiments, the rotor assembly 24 can comprise a plurality of rotor laminations 38. As shown in FIG. 2, in some embodiments, at least some of the rotor laminations 38 can include a first aperture 40. In some embodiments, the first apertures 40 can comprise a generally circular shape, and in other embodiments, the apertures 40 can comprise other shapes such as rectangular, square, slot-like, elliptical, and other regular and/or irregular polygonal shapes. Moreover, in some embodiments, some laminations 38 can include first apertures 40 comprising combinations of shapes (i.e., one lamination 38 can include a square aperture, a circular aperture, a rectangular aperture, etc.).

In some embodiments, after the rotor laminations 38 are substantially assembled to form at least a portion of the rotor assembly 24, the first apertures 40 can substantially align to form at least one magnet channel 43 so that at least one permanent magnet 42 can be housed within the rotor assembly 24. In some embodiments, the first apertures 40 and magnet channels 43 can be configured so that a series of magnetic poles are established after positioning the magnets 42 with in the magnet channels 43. In some embodiments, a filler material 36, such as plastic, steel, steel with a filler metal, etc., can be positioned (e.g., injected or directed) around the magnets 42 to secure the magnets 42 within the magnet channels 43.

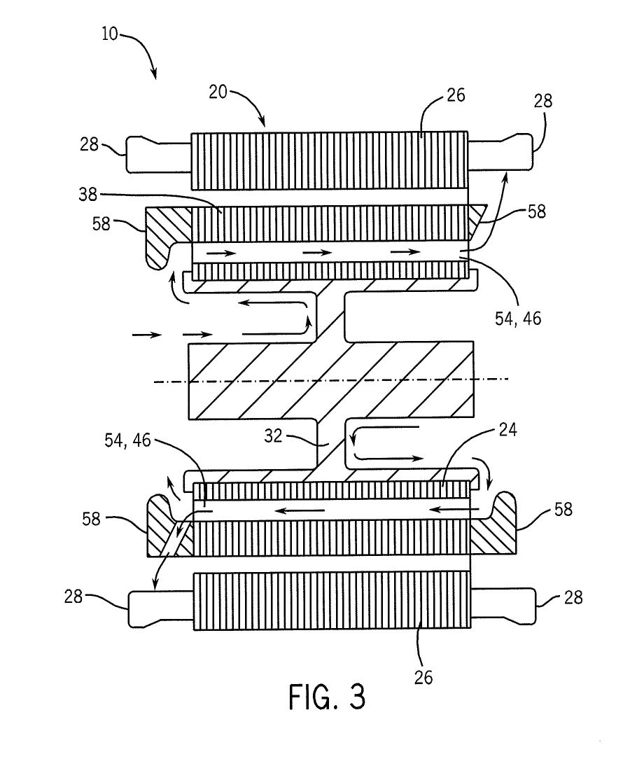

In some embodiments, second apertures 44 can be positioned in some or all of the rotor laminations 38 adjacent to the location of the magnets 42, as shown in FIG. 3. For example, one or more first coolant channels 46 can be created through at least a portion of the rotor assembly 24. In some embodiments, the laminations 38 can be arranged and configured so that the second apertures 44 in each lamination 38 can align to create the first coolant channels 46 extending an entire axial length of the rotor assembly 24 (i.e., from one axial side of the rotor assembly 24 to another axial side of the rotor 24), as shown in FIG. 3. In other embodiments, some or all of the first coolant channels 46 can extend through rotor assembly 24 less than the axial length of the rotor assembly 24 (not shown). In some embodiments, the first coolant channels 46 can be positioned between some of the magnets 42 in each lamination 38, as shown in FIGS. 4, 5B, and 6B. In some embodiments, the second apertures 44, and, as a result, the coolant channels 46, can be positioned either symmetrically or asymmetrically throughout each lamination 38 (i.e., each second aperture 44 can be positioned at about the same location between each set of magnets 42, or at different locations between magnets 42). Moreover, in some embodiments, at least some of the first coolant channels 46 can be in fluid communication with the machine cavity 22.

In some embodiments, the first coolant channels 46 can be located generally along one or more Q-axes 48. As best shown in FIGS. 2 and 4, the Q-axis 48 can be located about halfway between two sets of magnets 42 (i.e., about 90 electrical degrees from a magnetic pole centerline). In some embodiments, the Q-axes 48 can comprise a generally magnetically active portion of the rotor assembly 24. For example, in some embodiments, at least a portion of magnetic flux produced by the magnets 44 can flow around, through, and/or adjacent to the Q-axes 48.

Referring to FIG. 1, in some embodiments, the module housing 12 can include a coolant jacket 50. In some embodiments, the sleeve member 14 can comprise the coolant jacket 50. In some embodiments, the coolant jacket 50 can substantially circumscribe at least a portion of the electric machine 20. In some embodiments, the coolant jacket 50 can substantially circumscribe at least a portion of an outer diameter of the stator assembly 26, including the stator end turns 28.

Further, in some embodiments, the coolant jacket 50 can contain a coolant that can comprise transmission fluid, ethylene glycol, an ethylene glycol/water mixture, water, oil, motor oil, or a similar substance. The coolant jacket 50 can be in fluid communication with a coolant source (not shown) which can pressurize the coolant prior to or as it is being dispersed into the coolant jacket 50, so that the pressurized coolant can circulate through the coolant jacket 50.

Also, in some embodiments, the module housing 12 can include coolant apertures 52 so that the coolant jacket 50 can be in fluid communication with the machine cavity 22. In some embodiments, the coolant apertures 50 can be positioned substantially adjacent to the stator end turns 28. For example, in some embodiments, as the pressurized coolant circulates through the coolant jacket 50, at least a portion of the coolant can exit the coolant jacket 50 through the coolant apertures 52 and enter the machine cavity 22. Also, in some embodiments, the coolant can contact the stator end turns 28, which can lead to at least partial cooling. After exiting the coolant apertures 52, at least a portion of the coolant can flow through the machine cavity 22 and can contact various module 10 elements, which, in some embodiments, can lead to at least partial cooling of the module 10.

In some embodiments, an additional volume of the coolant also can be expelled from or adjacent to the rotor hub 32 or from the output shaft 34. For example, in some embodiments, an output shaft coolant channel (not shown) can fluidly connect a coolant source (not shown) with a rotor hub coolant channel (not shown), which can be in fluid communication with the machine cavity 22. As a result, coolant can be dispersed from the rotor hub 36 and/or the output shaft 34. At least a portion of the coolant expelled near the rotor hub 36 can flow radially outward toward the housing 12 (e.g., due to centrifugal force). In some embodiments, similar to coolant exiting the coolant apertures 52, the additional volume of coolant can flow through the machine cavity 22 and can contact various module 10 elements, which, in some embodiments, can lead to at least partial cooling of the module 10.

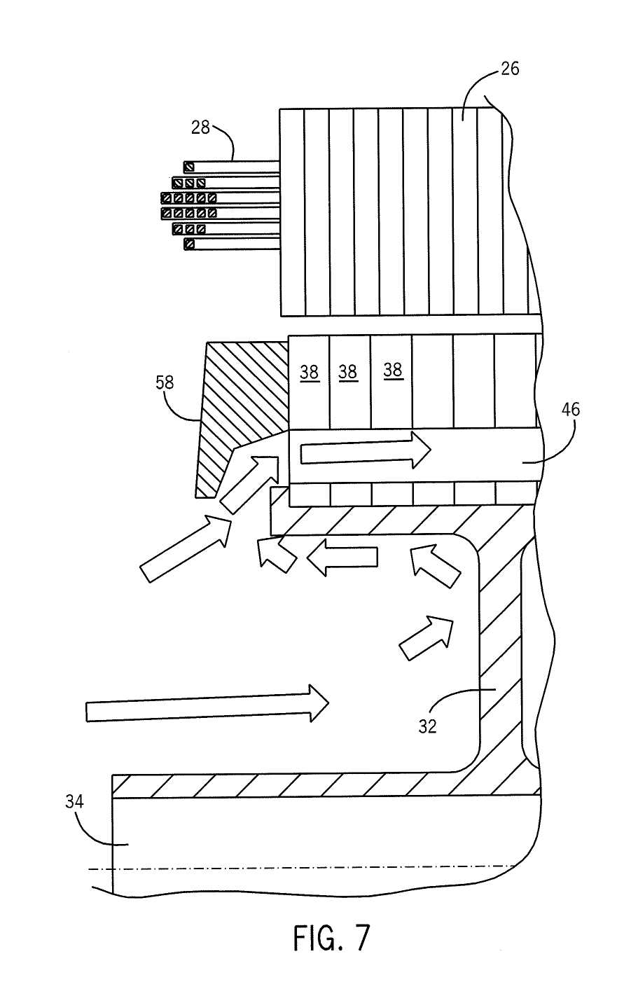

In some embodiments, at least a portion of the coolant that entered the machine cavity 22 through coolant apertures 52 and/or any other entry point can pass through the first coolant channels 46, as shown by the arrows in FIGS. 3 and 7. In some embodiments, the coolant can flow through the first coolant channels 46 in either axial direction (i.e., right to left or left to right). Moreover, with respect to FIGS. 3 and 7, in some embodiments comprising multiple first coolant channels 46, coolant can flow through the first coolant channels 46 in multiple directions substantially simultaneously (i.e., coolant flows through a first coolant channel in a left to right direction and coolant also flows right to left through a second coolant channel at substantially the same time). Such counter-flow cooling can reduce temperature gradients in the axial direction.

In some embodiment, as the coolant flows through the first coolant channels 46, heat energy can be removed from the rotor laminations 38, which can lead to at least a partial reduction in the amount of heat contained around the magnets 42 (i.e., from operation of the electric machine 12). In some embodiments, as the heat energy around the magnets 42 is reduced, the electric machine 12 can operate at higher levels of performance. In addition, by extracting the heat from the magnets 42, the propensity of demagnetization of the magnets 34 can also be reduced. In some embodiments, after flowing through at least some of the first coolant channels 46, the coolant can re-enter the machine cavity 22 where it can contact other elements of the module 10, which can lead to module 10 cooling.

In some embodiments, by placing at least some of the first coolant channels 46 along and/or adjacent to the Q-axis 48, the coolant flowing through the first coolant channels 46 can extract heat from multiple magnets 42 at approximately the same time. In addition, the effect on machine performance by including the first coolant channels 46 along the Q-axis can be minimized to a point that it is not discernable in some applications. Further, the first coolant channels 46 added to the rotor assembly 24 can reduce rotational inertia and the mass of the rotor assembly 24, which can be beneficial in some applications.

In some embodiments, the rotor assembly 24 also can comprise at least one second coolant channel 54. In some embodiments, at least one second coolant channel 54 can be positioned within some the first apertures 40, as shown in FIGS. 6A and 6B. More specifically, in some embodiments, the second coolant channels 54 can be created through portions of the filler material 36 within some or all of the first apertures 40. For example, in some embodiments, after positioning the magnets 42 with the first apertures 40 and adding the filler material 36 to the first apertures 40, the second coolant channels 54 can be created (i.e., drilled or otherwise formed). In some embodiments, the second coolant channels 54 can substantially extend the axial distance of the rotor assembly 24 and can be in fluid communication with the machine cavity 22. In other embodiments, the second coolant channels 54 can extend less than the axial distance of the rotor assembly 24 and at least one end of the second coolant channels 54 can be in fluid communication with the machine cavity 22. In some embodiments, similar to the coolant channels 46, at least a portion of the coolant can flow through the second coolant channels 54 to aid in cooling the magnets, as previously mentioned. In some embodiments, the rotor assembly 24 can comprise at least one first coolant channel 46 and at least one second coolant channel 54 so that at least a portion of the coolant can flow through both coolant channels 46, 54.

Moreover, in some embodiments, the magnets 42 can be coupled to at least one inner wall 56 of the magnet channels 43. In some embodiments, the coupling can comprise an adhesive or conventional fastener to couple the magnet 42 to the inner walls 56 so that the module 10 can function without the filler material 36. As a result, in some embodiments, at least a portion of the coolant can circulate through portions of the magnet channels 43 immediately adjacent to the magnets 42, which can further enhance magnet cooling.

In some embodiments, balance rings and/or coolant guides 58 can be positioned on at least one axial end of the rotor assembly 24 so that at least a portion of the coolant can be guided, directed, and/or urged toward the first coolant channels 46 and/or the second coolant channels 54. As reflected by the arrows in FIGS. 3 and 7, in some embodiments, centrifugal forces created during machine 20 operation can aid the coolant guide 58 in guiding coolant to the coolant channels 46, 54. As a result, coolant that is supplied to the machine cavity 22 can reach the coolant channels 46, 54. Moreover, in some embodiments, the coolant guides 58 can also help guide the coolant out of the coolant channels 46, 54. For example, in some embodiments, the coolant guides 58 can generally direct coolant toward the stator end turns 22, as shown in FIG. 3.

As shown in FIGS. 3 and 7-10, in some embodiments, the coolant guide 58 can comprise a generally annular member operatively coupled to at least one axial end of the rotor assembly 24 so that the coolant guide 58 can rotate substantially synchronously with the rotor assembly 24. In some embodiments, the coolant guide 58 can include other shapes such as square, rectangular, hemi-spherical, elliptical, regular and/or irregular polygonal, or a combination thereof. Moreover, in some embodiments, the coolant guide 58 can be configured so that the coolant can flow in generally opposite directions at each consecutive index of the coolant channels 46, 54 (e.g., at some magnet poles). As a result, the coolant guides 58 can alternate between directing the coolant substantially inward at a first one axial end of the rotor assembly 24 and guiding the coolant substantially outward at a second axial end, and then guiding the coolant outward at the first axial end of the rotor and directing the coolant inward at the second axial end (i.e., a generally alternating configuration).

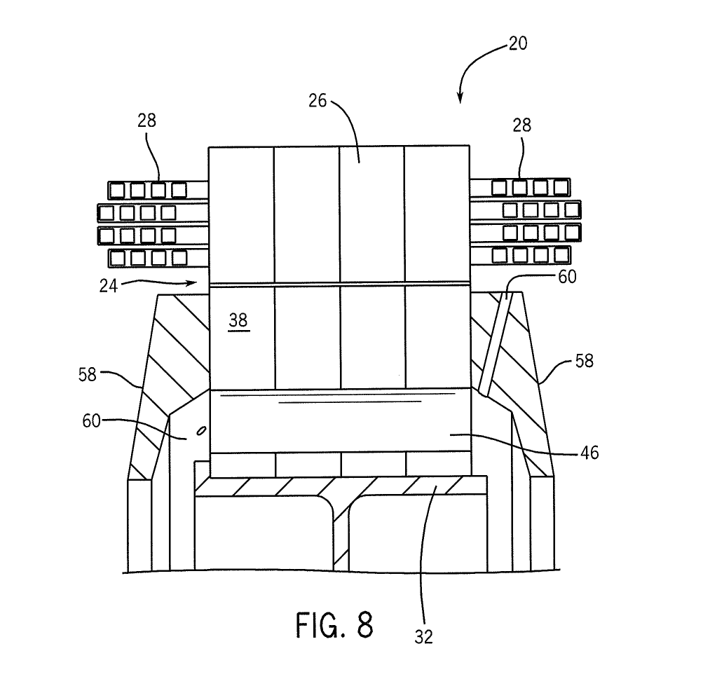

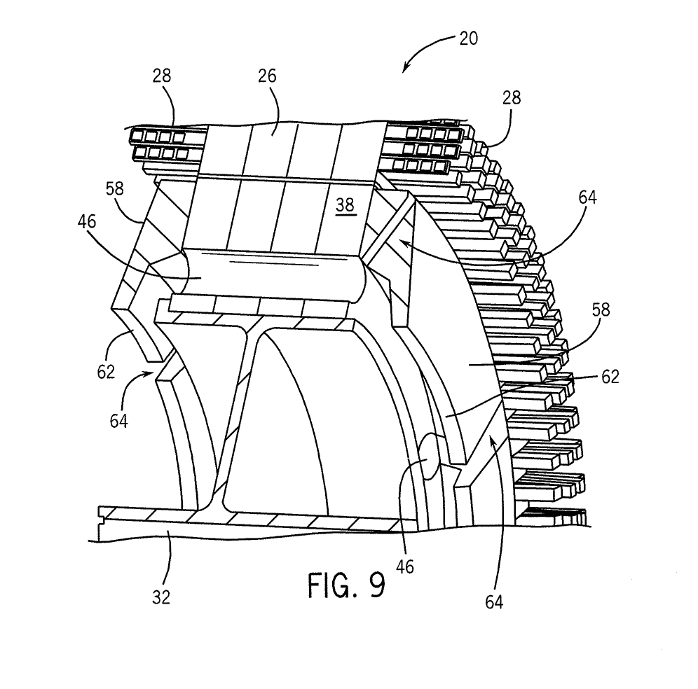

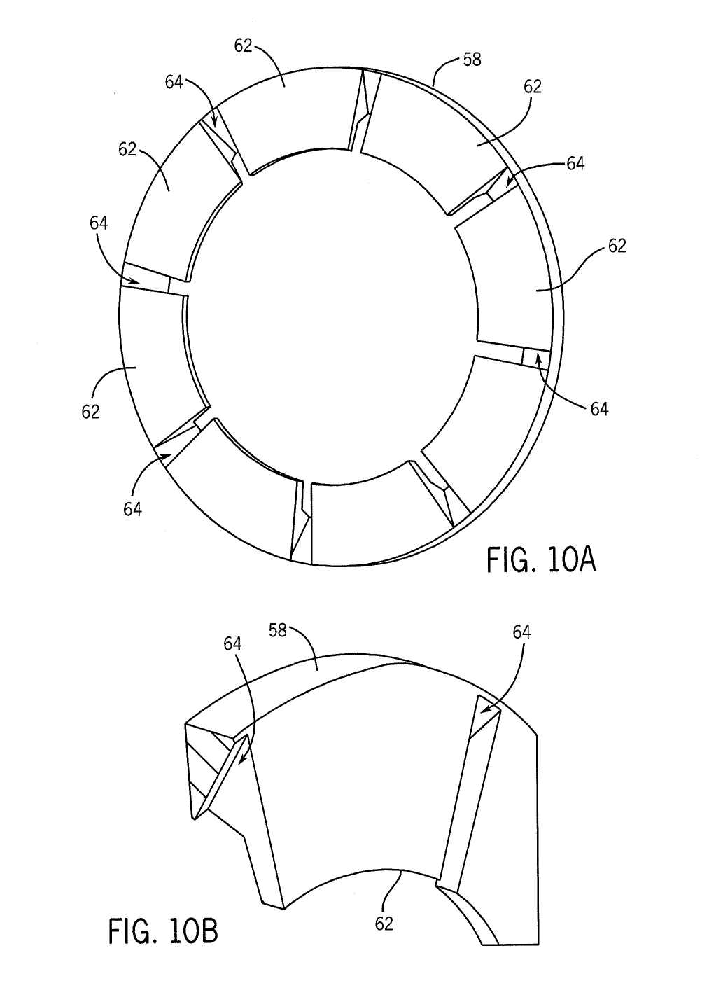

In some embodiments, the coolant guide 58 can comprise multiple configurations. For example, as shown in FIG. 8, the coolant guide 58 can include at least one aperture 60 through a portion of the coolant guide 58 to direct a portion of the coolant flowing through the coolant channels 46, 54 toward other portions of the module 10 (e.g., the stator end turns 28). In addition, in some embodiments, the coolant guide 58 can comprise a textured or “wavy” surface, as shown in FIGS. 9 and 10A and 10B. For example, a peak 62 of the wavy surface can direct the coolant in towards the coolant channels 46, 54, and a valley 64 of the wavy surface can direct the coolant outward away from the coolant channels 46, 54. In some embodiments, the peaks 62 and valleys 64 can alternate in a substantially circumferential direction. In some embodiments, the coolant guide 58 can comprise peaks 62, valleys, 64, and apertures 60, and any combination thereof.

In some embodiments, the coolant guide 58 can comprise steel, aluminum, plastic, or any other suitable material. In some embodiments, the coolant guide 58 can be integrated directly into the rotor laminations 38 and/or the rotor hub 32. In other embodiments, the coolant guide 58 can be a secondary component that is secured to either axial end of the rotor assembly 24 and/or the rotor hub 32. In one embodiment, the coolant guide 58 can be integrated directly with the filler material 36 that is used to secure the magnets inside the slots. As a result, the coolant guide 58 can function as an “end cap” over at least one of the axial ends of the magnets.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. An electric machine module comprising:
an electric machine including a rotor assembly, the rotor assembly including
a plurality of rotor laminations, at least some of the plurality of rotor laminations comprising at least one first aperture positioned through a portion of the rotor laminations,
the first apertures configured and arranged to form at least one magnet channel when the rotor assembly is substantially assembled, at least one permanent magnet positioned in the at least one magnet channel,
at least one second aperture positioned through a portion of at least some of the plurality of rotor laminations along a Q-axis and adjacent to the at least one magnet channel, and
the second apertures configured and arranged to form at least one first coolant channel when the rotor assembly is at least partially assembled.

2. The electric machine module of claim 1 and further comprising a filler material in at least some of the magnet channels.

3. The electric machine module of claim 2 and further comprising a second coolant channel defined through a portion of the filler material.

4. The electric machine module of claim 1 and further comprising a stator assembly circumscribing at least a portion of the rotor assembly.

5. The electric machine module of claim 1 and further comprising a module housing and a machine cavity at least partially defined by portions of the module housing, at least a portion of the electric machine enclosed by the module housing and positioned in the machine cavity.

6. The electric machine module of claim 5 and further comprising a coolant jacket positioned in a portion of the module housing, the coolant jacket configured to substantially circumscribe a portion of the electric machine and at least one coolant aperture defined through a portion of the machine cavity so that the coolant jacket is in fluid communication with the machine cavity.

7. The electric machine module of claim 6, wherein the first coolant channel is in fluid communication with the machine cavity.

8. The electric machine module of claim 1 and further comprising at least one coolant guide operatively coupled to an axial end of the rotor assembly.

9. An electric machine module comprising
an electric machine including a stator assembly with stator end turns and a rotor assembly, the stator assembly circumscribing at least a portion of the rotor assembly;
a module housing enclosing the electric machine, at least a portion of the module housing defining a machine cavity;
the rotor assembly including at least one magnet channel and at least one first coolant channel, the at least one magnet channel and at least one first coolant channel extending in an axial direction through at least a portion of the rotor assembly;
at least one permanent magnet positioned in the at least one magnet channel;
the at least one first coolant channel having a portion positioned along a Q-axis adjacent to the at least one magnet channel; and
at least one coolant guide operatively coupled to the rotor assembly.

10. The electric machine module of claim 9 and further comprising a filler material positioned in the magnet channel immediately adjacent to the at least one permanent magnet.

11. The electric machine module of claim 10 wherein the rotor assembly further comprises at least one second coolant channel.

12. The electric machine module of claim 9 and further comprising a coolant jacket positioned in a portion of the module housing, the coolant jacket configured to substantially circumscribe a portion of the electric machine and at least one coolant aperture defined through a portion of the machine cavity so that the coolant jacket is in fluid communication with the machine cavity.

13. The electric machine module of claim 9, wherein the at least one first coolant channel and the at least one magnet channel are in fluid communication with the machine cavity.

14. The electric machine module of claim 9 wherein the rotor assembly comprises two axial ends and at least one coolant guide operatively coupled to each of the axial ends of the rotor assembly.

15. The electric machine module of claim 14 wherein at least one of the coolant guides operatively coupled to one of the axial ends of the rotor assembly comprises at least one aperture.

16. The electric machine of claim 14 wherein a portion of at least one of the coolant guides operatively coupled to one of the axial ends of the rotor assembly is configured and arranged to direct a coolant toward the stator end turns.

17. The electric machine module of claim 14 a portion of at least one of the coolant guides operatively coupled to one of the axial ends of the rotor assembly is configured and arranged to direct a coolant into at least one of the first coolant channel and the magnet channel.

18. A method of cooling an electric machine module, the method comprising:
providing an electric machine including a rotor assembly;
positioning at least one magnet channel through a portion of the rotor assembly;
inserting at least one permanent magnet in the at least one magnet channel; and
positioning at least one first coolant channel through at least a portion of the rotor assembly substantially along a Q-axis and adjacent to the at least one magnet channel.

19. The method of claim 18 and further comprising positioning a filler material substantially within the at least one magnet channel and providing at least one second coolant channel through a portion of the filler material.

20. The method of claim 18 and further comprising operatively coupling at least one coolant guide to the rotor assembly.
